(19) United States
(12) Patent Application Publication
(10) Pub. No.: US 2006/0246796 A1
(43) Pub. Date: Nov. 2, 2006

(54) Composite curing

(75) Inventor: Roger Philip Duffy, Lancashire (GB)

Correspondence Address: CROWELL & MORING LLP;INTELLECTUAL PROPERTY GROUP, P.O. BOX 14300, WASHINGTON, DC, 20044-4300, US

(73) Assignee: BAE Systems plc, London (GB)

(21) Appl. No.: 10/518,241

(22) PCT Filed: Nov. 18, 2004
(86) PCT No.: PCT/GB04/04876

§ 371 Date: Dec. 16, 2004

(30) Foreign Application Priority Data
Nov. 27, 2003 (GB) 0327568.2
Nov. 27, 2003 (EP) 03257470.9

(51) Int. Cl. B32B 37/00; B29C 70/44

(52) U.S. Cl. 442/38; 156/286; 156/87

(57) ABSTRACT

A breather sheet for use in the curing of a composite part comprising two outer layers interposed with a mesh, each outer layer provided with an arrangement of holes and fixed in position to provide a plurality of passageways for air and/or volatiles to pass without restriction, the passageways being such that interposition of the mesh in the assembly of the breather sheet does not substantially obstruct any of the passageways however the mesh is positioned or orientated relative to the outer layers.

This invention relates to the field of composite curing, particularly to a breather sheet for use in vacuum bagging.

Autoclave curing of composites is commonly used to manufacture aerospace laminate components. Vacuum bagging is employed to create pressure on a laminate during its cure cycle. Pressurising a composite laminate consolidates the laminate plies, removes air trapped between layers and optimises the fibre-to-resin ratio of the composite part. Before curing, processing materials are applied to the composite ply lay-up to control the resin content of the cured part and ensure proper application of autoclave pressure to the lay-up. A release film is placed against the uncured laminate and is used as a barrier between the laminate and the subsequent layers. A breather sheet is used to maintain a path throughout the bag to the vacuum source, enabling air and volatiles produced as the laminate cures to escape whilst continuous pressure is applied in the curing of the laminate. The breather layer also absorbs any excess resin bled from the laminate. Typically, synthetic fibre materials such as felt, and/or fibreglass fabric, are used as breather sheets. An impervious membrane surrounds the breather sheet, to contain any vacuum pressure applied to the lay-up before and during the cure and to transmit external autoclave pressure to the part. It also prevents any gaseous pressurising medium used in the autoclave from permeating the part and causing porosity which is undesirable because it would adversely affect the strength characteristics of the cured composite component. In addition, any such pressuring gas could affect the surface finish of the component. A mould tool surrounds the matrix of layers (or “ancillaries”), to apply pressure to the component during curing.

Compression of layers during autoclave curing causes several problems, particularly with the breather layer. The pores in the breather material tend to close, or the pores may become blocked by excess resin, causing ‘lock-off’ of the breather layer. This means that the breather layer is no longer pervious enough for air and volatiles to escape from the ply lay-up, leading to the production of a porous, low-quality part and/or one with a poor surface finish. Lock-off can also prevent a uniform pressure being applied to the laminate, leading to surface imperfections in and/or distortion of the composite component.

The breather sheet material may wrinkle during compression. This is highly disadvantageous because the wrinkles cause unacceptable creasing in the laminate and/or defects in the surface of the component. As the ancillaries are assembled, particularly on complex or severely shaped components and/or ones having a significant vertical dimension, there is a tendency for the breather layer material, and the other ancillaries, to sag, again causing creasing in the laminate and/or imperfections in the surface of the component.

The present invention aims to overcome or at least substantially reduce some of the above mentioned problems.

Accordingly, the present invention provides a breather sheet for use in the curing of a composite component comprising two distinct, affixed outer layers with a mesh layer interposed therebetween, each of the outer layers being provided with a plurality of holes prior to assembly of the breather sheet, the holes being configured and disposed such that when the two outer layers are fixed together to form the breather sheet a plurality of passageways is formed for air and/or volatiles to pass freely through the breather sheet, the passageways being configured and disposed such that the interposition of the mesh layer in any position or orientation relative to the outer layers does not substantially obstruct all of the passageways.

The plurality of holes in the outer layers and the interposing mesh ensure porosity of the breather sheet, thus avoiding ‘lock-off’ of the breather sheet, so that air and volatiles can escape and continuous pressure can be applied to the laminate. This allows a non-porous composite component, of high quality surface finish, to be produced; moreover, the breather sheet can easily be reused. In processes where hard tooling or rubber moulding is used, the breather sheet provides a bulk-free breather which does not lock off in use, and allowing segmented tooling to be used.

Preferably, the outer layers are made from semi-rigid material. A semi-rigid structure provides the breather sheet with a well-defined size and shape, and of very uniform thickness, and the sagging of layers to the bottom of the structure and formation of wrinkles on compression of the matrix layers during the curing process is prevented, improving the surface quality of the part. Further, any slight mis-shaping of the breather sheet can be accepted because, when the pack is placed inside the mould tool and placed under compression, the semi-rigid structure can flex to adopt the correct shape. If the layers of semi-rigid material and mesh are bonded together with an adhesive and the resulting breather sheet is required to be flexible, the adhesive used is preferably one which, when set is soft and flexible (a “conformal” adhesive) so that it is able to flex with the breather sheet, to prevent the sheet from buckling when flexed.

Advantageously, the mesh is incompressible across its plane. The incompressible mesh holds the outer layers of the breather sheet apart, maintaining the passageways through the breather sheet, and also ensures that the breather sheet is of uniform thickness.

Optionally, the layers of semi-rigid material and mesh may be bonded together with adhesive, and without substantially blocking the passageways provided by the holes. The adhesive holds the layers together in an integral unit, improving the ease of use of the breather sheet. The use of local spots of adhesive, rather than a wide spread, ensures that the passageways through the breather sheet, provided by the holes in the outer layers and the mesh, are not substantially blocked. If the breather sheet is not required to flex in use, the adhesive may be one which is rigid when set.

Optionally, at least a portion of the circumference of the breather sheet is adapted to abut another breather sheet in such a way that adjacent breather sheets can be used to form a composite breather pack. Placing the breather sheet around structures, particularly large structures, can be difficult, but having interlocking or adjacent sections of breather sheet eases the placement of a composite breather pack around the structure, each section being placed on the structure, and locked into place against adjacent sections.

Advantageously, the breather sheet is pre-formed to the required shape for the composite part. This further eases the process of placing the breather sheet around a structure.

According to another aspect of the invention, there is provided a method of assembling a breather sheet comprising two outer layers and a mesh layer such that the assembled breather sheet has a plurality of passageways therethrough for the free passage of fluid, the method comprising interposing a mesh layer between two outer layers, each of which is provided with a plurality of holes, aligning the two outer layers and the mesh layer, and fixing the layers together to form a unitary breather sheet.

The invention will now be described by way of example and with reference to the accompanying drawings, in which:

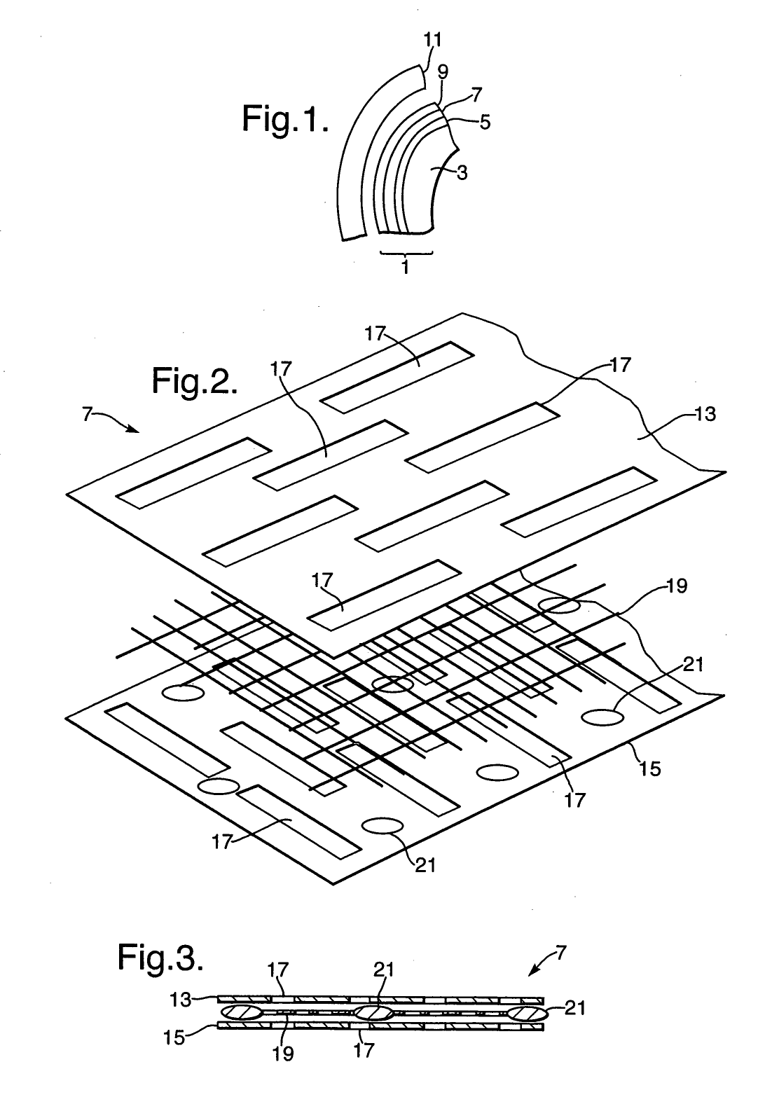

FIG. 1 is a schematic view of a matrix of layers before curing of a laminate component and incorporating a breather sheet in accordance with the invention.

FIG. 2 is an exploded view of the breather sheet of in FIG. 1 prior to its assembly.

FIG. 3 is a cross-section view of the breather sheet after assembly.

In FIG. 1 a matrix of layers 1 in the manufacture of a composite laminate component 3. Individual prepregs are stacked to form a laminate 3, which is then covered with successive layers of porous fabric and a vacuum bag in the form of a nylon membrane 9. Thermosetting resins are polymerised by applying temperatures and pressures for a finite time. Pressure is applied to squeeze excess resin out of the composite component 3 and to consolidate individual layers. A release film 5 is placed against the uncured laminate 3 and is used as a barrier between the laminate 3 and subsequent layers to facilitate disassembly once the composite component has been cured. A breather sheet 7 is used to maintain a flow path, to enable air and volatiles to escape from the component 3, and uniform pressure to be applied to the laminate. The impervious nylon membrane 9 surrounds the breather sheet 7, to contain any vacuum pressure applied to the component 3 before and during the cure and to transmit external autoclave pressure to the component 3. It also prevents any gaseous pressurising medium used in the autoclave from permeating the component and causing porosity of the part. A mould tool 11 surrounds the matrix of layers.

The breather sheet, shown in FIG. 2, comprises two outer layers 13, 15 of semi-rigid material, such as carbon fibre or glass fibre, each provided with a different arrangement of holes 17 over substantially its entire surface. The holes 17 are provided in the distinct outer layers 13, 15 prior to assembly of the breather sheet 7. A mesh layer 19, typically of PTFE-coated Kevlar or similarly incompressible material, is provided between the two layers 13, 15 of semi-rigid material. The breather sheet 7 is assembled by aligning the two outer layers 13, 15 such that the holes 17 therein are superposed to provide clear passageways through the assembly, and then interposing the mesh layer 19 between the two outer layers 13, 15 so that the passageways are not obstructed. Advantageously, the holes 17 are sized and disposed in each outer layer such that the interposition of the mesh layer 19 cannot substantially obstruct the passageways however the mesh layer 19 is positioned or orientated relative to the outer layers 13, 15. The three layers are then bonded together with local spots 21 of adhesive. As illustrated in the cross-sectional view of FIG. 3, the adhesive bonds the two layers 13, 15 together, holding the mesh firmly sandwiched between them. The local spots 21 of adhesive do not substantially block the passageways provided through the breather sheet, the holes in the semi-rigid material layers being of a size and configuration such that a plurality of passageways are provided to enable air and volatiles, to flow through the breather sheet without restriction. The different arrangement of holes in each layer of semi-rigid material assists this.

The semi-rigid structure of the breather sheet helps ease the assembly of the matrix layers. Sagging of the layers downwardly under gravity is prevented, and the thickness of the breather sheet is made more uniform. Any variation/reduction in the thickness of the breather sheet may reduce the quality of the component due to the inability of the breather sheet to absorb the necessary amount of resin and it may adversely affect the dimensional accuracy of the component. If there is excess resin in the laminate, the properties of laminate will be discussed by those of the resin. If there is too little resin weak spots will be created in the component. The key to obtaining the strength-to-weight advantage of composites is the optimisation of the fibre-to-resin ratio. It is therefore important to ensure that the thickness of the breather sheet is uniform around the component and this is facilitated by the assembled breather sheet being incompressible and of substantially uniform thickness. This is achieved by virtue of the mesh layer being effectively incompressible in a direction perpendicular to its plane. The semi-rigid structure also prevents the formation of wrinkles on compression of the matrix layers, leading to improved surface quality in the finished component.

Having described embodiments of the invention, numerous modifications will now become apparent to the skilled person.

While it is advantageous, it is not necessary for each layer of semi-rigid material to be provided with an arrangement of holes different to that provided on adjacent layers of semi-rigid material. Additionally, it will be appreciated that the size of the holes is not critical, but the interconnection of these across the breather sheet is; the interconnections must always be sufficient to maintain the flow paths for air and/or volatiles through the breather sheet.

The semi-rigidity of the breather sheet enables it to be pre-formed to the shape required for the component. With the prior art breather layers, it is difficult to ensure that there is enough breather material in tight radii of the component so that bridging does not occur. Pre-forming of a semi-rigid breather sheet as described herein avoids this problem.

1. A breather sheet for use in the curing of a composite part comprising two distinct, affixed outer layers with a mesh layer interposed therebetween, each of the outer layers being provided with a plurality of holes prior to assembly of the breather sheet, the holes being configured and disposed such that when the two outer layers are fixed together to form the breather sheet a plurality of passageways is formed for air and/or volatiles to pass freely through the breather sheet, the passageways being configured and disposed such that that the interposition of the mesh layer in any position or orientation relative to the outer layers does not substantially obstruct all of the passageways.

2. A breather sheet as claimed in claim 1 wherein the outer layers are made of a semi-rigid material.

3. A breather sheet as claimed in claim 1, wherein the mesh layer is incompressible in one plane.

4. A breather sheet as claimed in claim 1, wherein the outer layers and mesh layer are bonded together with adhesive.

5. A breather sheet as claimed in claim 1, wherein at least a portion of the circumference of the breather sheet is adapted to abut another breather sheet in such a way that adjacent breather sheets can be used to form a composite breather pack.

6. A breather sheet as claimed in claim 1, pre-formed to the required shape for the composite component.

7. A method of assembly of a breather sheet comprising two other layers and a mesh layer such that the assembled breather sheet has a plurality of passageways therethrough for the free passage of air and/or volatiles, the method comprising interposing a mesh layer between two other layers, each of which is provided with a plurality of holes prior to assembly, aligning the two outer layers and the mesh layer, and fixing the layers together to form a unitary breather sheet.

8. A method according to claim 7 comprising bonding the two outer layers together with the mesh sandwiched there between.

9. A method according to claim 7, comprising shaping the two outer layers to form a breather sheet of a predetermined shape.

10. Use of a breather sheet as claimed in claim 1, in the curing of a composite part.
